(19) United States
(12) Patent Application Publication
(10) Pub. No.: US 2023/0270286 A1
(43) Pub. Date: Aug. 31, 2023

(54) OVEN

(71) Applicant: Gozney Group Limited, Christchurch Dorset (GB)

(72) Inventor: Thomas Robert GOZNEY, Dorset (GB)

(21) Appl. No.: 17/800,653

(22) PCT Filed: Feb. 16, 2021
(86) PCT No.: PCT/EP2021/053772

§ 371 Date: Aug. 18, 2022

(30) Foreign Application Priority Data
Feb. 19, 2020 (GB) 2002304.0

(51) Int. Cl. A47J 37/06; F24C 1/04; A23B 4/052

(52) U.S. Cl. CPC A47J 37/0647; F24C 1/04; A47J 37/0664; A47J 37/0658; A23B 4/052; A47J 2202/00

(57) ABSTRACT

Disclosed is an oven comprising: an oven housing defining an oven chamber for containing foodstuffs during cooking or curing; and an oven floor forming a base of the oven chamber for supporting foodstuffs to be cooked or cured in the oven chamber, wherein the oven floor comprises: a first aperture for communication with a non-gas-fuel energy source for cooking or curing foodstuffs in the oven chamber; and a second aperture for communication with a gas-fuel energy source for cooking or curing foodstuffs in the oven chamber.

### CROSS-REFERENCE TO RELATED APPLICATIONS

The present application is a U.S. National Stage filing under 35 U.S.C. 371(c) of International Application No. PCT/EP2021/053772, filed Feb. 16, 2021, which claims priority to Great Britain Patent Application No. 2002304.0, filed Feb. 19, 2020, the disclosures of which are hereby incorporated by reference in their entireties.

The present disclosure relates to ovens and is particularly, although not exclusively, concerned with a multi-fuel oven.

### BACKGROUND

Ovens for cooking or curing foodstuffs are known. Most ovens are dedicated to being operated with a single energy source, such as a gas burner, and electric heating element, or a solid-fuel fire only.

More recently, some ovens, such as the Roccbox™, have been developed with a modular arrangement for heating the oven using either one of a gas-fuel heat source or a solid-fuel heat source which can be connected to the oven.

Further developments in the field of ovens would be desirable.

### STATEMENTS

According to a first aspect of the present disclosure, there is provided an oven comprising: an oven housing defining an oven chamber for containing foodstuffs during cooking or curing; and an oven floor forming a base of the oven chamber for supporting foodstuffs to be cooked or cured in the oven chamber, wherein the oven floor comprises: a first aperture for communication with a first energy source for cooking or curing foodstuffs in the oven chamber; and a second aperture for communication with a second energy source for cooking or curing foodstuffs in the oven chamber.

It should be appreciated that there are many types of processes which can come under the term “cooking” and “curing”. In the context of the present disclosure, these terms should be understood to encapsulate various methods of treating foodstuffs in the oven by applying energy to them from an energy source. For example, other than simply heating, cooking may include (but is not limited to) heating, roasting, steaming, or baking foodstuffs. Further, curing may include (but is not limited to) hot-smoking, cold-smoking, or dehydrating foodstuffs.

The energy sources are configured to be in fluid communication with the oven chamber via their respective apertures.

The first energy source may be a non-gas-fuel energy source.

The second energy source may be a gas-fuel energy source.

Either of the energy sources may be an electrical energy source.

The oven may further comprise a blanking cap for selectively covering the second aperture. The blanking cap may be used to cover and protect the second energy source when it is not in use, and may provide additional area for foodstuffs on the oven floor.

The oven may further comprise a blanking cap for selectively covering the first aperture. The blanking cap may be used to cover and protect a first energy source when it is not in use, and may provide additional area for foodstuffs on the oven floor.

When a blanking cap is placed in one of the first and/or second apertures, the blanking cap may form a substantially continuous surface with the oven floor, such that the area of the aperture can be used for supporting foodstuffs for cooking or curing by the blanking cap. Accordingly, when an energy source in one of the apertures is not in use, the available area of the oven floor can be maximize.

The first and second apertures may be substantially identical in size and/or shape. This may be convenient for manufacturing purposes, or may enable the same blanking cap be used to cover either of the first or second apertures. The oven may be provided with two blanking caps for blanking both of the first and second apertures, for example when a energy source inside the oven chamber is to be used, for example a log fire. This may maximize area for foodstuffs and prevent debris from damaging or affecting the first or second, or gas- or non-gas-energy sources.

The first and/or second aperture may be circular in shape. The blanking cap or caps may also be circular in shape. Accordingly, the blanking caps may be conveniently inserted into an aperture in any orientation.

The one or more blanking caps may be formed from a material which is particularly good at absorbing heat. In particular, the blanking caps may be formed from substantially the same material as the oven floor and/or from cast iron.

The first and second apertures may be spaced apart across a width of the oven floor. In some examples, the first and second apertures may be arranged on opposing lateral areas of the oven floor. In particular, the first and second apertures may be arranged on opposing sides of an oven mouth of the oven that provides access to the oven chamber.

The first and second apertures may each be arranged proximate a peripheral edge of the oven floor. This may maximize the area for foodstuffs in the center of the oven floor.

The oven may comprise a temperature sensor for measuring a temperature within the oven chamber, and wherein the first and second apertures are arranged substantially equidistant from the temperature sensor. This may serve to ensure that the temperature sensor provides accurate and consistent readings regardless of which energy source is being used.

The first or non-gas-fuel energy source may be arranged below the oven floor. The first or non-gas-fuel energy source may be arranged within a cavity formed below the first aperture.

The second aperture may contain a permanent gas-fuel energy source. It should be understood that the second aperture defines a cavity within which the second or gas-fuel energy source may be contained. By permanent, it should be understood that the second or gas-fuel energy source is located within the second aperture even when it is not in use. If a blanking cap is provided, then the blanking cap may be used to cover the second aperture when the second or gas-fuel energy source is not in use.

The first and/or second aperture may be surrounded by a peripheral wall which projects upwardly from the oven floor. Optionally, the peripheral wall may be removable.

The oven floor may form a substantially continuous surface. It should be understood that the oven floor may form a substantially continuous surface, aside from the first and second apertures for communication with the energy sources. The continuous surface may be formed from more than one oven floor panel, but there may be essentially no gaps between separate panels of the oven floor. The oven floor may be substantially impermeable. The oven floor may not be a slatted ‘grill’ type support surface, as are commonly found on a charcoal or gas barbeque, typically constructed from metal wire. The oven floor may be formed from stone or ceramic material. Accordingly, heated air and/or smoke from the energy sources may only pass into the oven chamber via the first and/or second apertures.

The oven floor may comprise a relief at the periphery of the first and/or second aperture for aiding removal of a blanking cap from the aperture or apertures.

To avoid unnecessary duplication of effort and repetition of text in the specification, certain features are described in relation to only one or several aspects of the invention. However, it is to be understood that, where it is technically possible, features described in relation to any aspect of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a front view of an exemplary oven according to the principles of this disclosure;

FIG. 2 is sectional plan view of the oven of FIG. 1;

FIG. 3 is a sectional perspective view of the oven of FIGS. 1 and 2; and

FIGS. 4a-c are a sectional perspective views of the oven of FIGS. 1-3 shown in various configurations.

### DETAILED DESCRIPTION

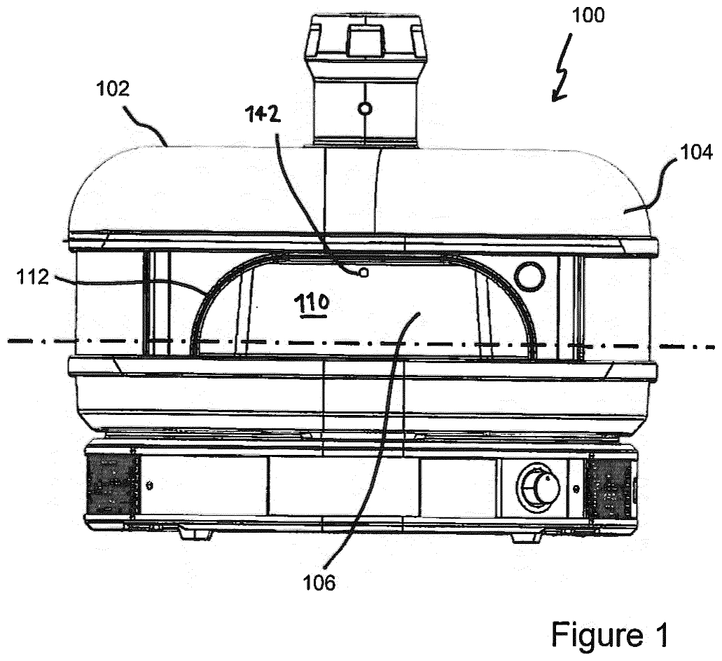

FIG. 1 shows an oven 100 according to the principles of the present disclosure. In this example, the oven may be a domestic oven for use by domestic chefs or a commercial oven for use by professional chefs, but it should be understood that the principles of this disclosure can be applied to many different types of oven.

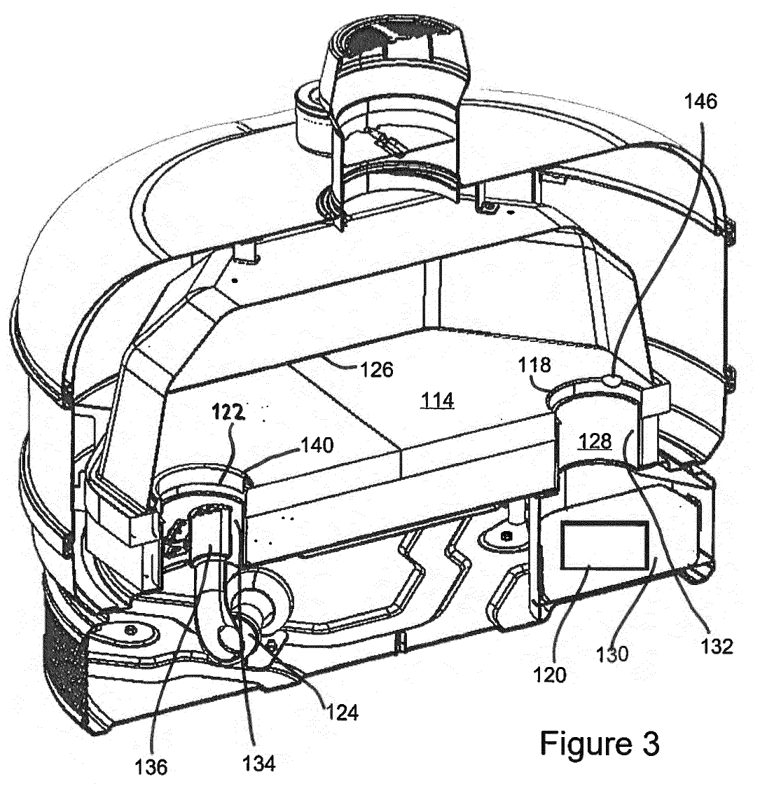

The oven comprises an oven housing 102. The housing 102 comprises an externally-facing outer housing layer 104 and an internally facing inner housing layer 106 (for more detail, see FIG. 3). Accordingly, the oven housing 102 is a dual-layer oven housing. The dual-layer housing construction provides an internal insulating cavity 108 (see FIG. 3) which assists in preventing the externally-facing outer housing layer 104 from becoming excessively hot during cooking, which would represent a severe burning risk.

The inner housing layer 106 defines an oven chamber 110 for containing foodstuffs during cooking or curing. The oven chamber 110 is formed internally within the oven. The housing comprises an oven mouth 112 formed at a front of the oven chamber 110 which provides access to the oven chamber 110 to insert and remove foodstuffs to be cooked or cured. The oven 100 may further comprise a door (not shown) to optionally close the oven mouth 112 and/or seal the oven chamber 110, which may be required for certain cooking or curing methods.

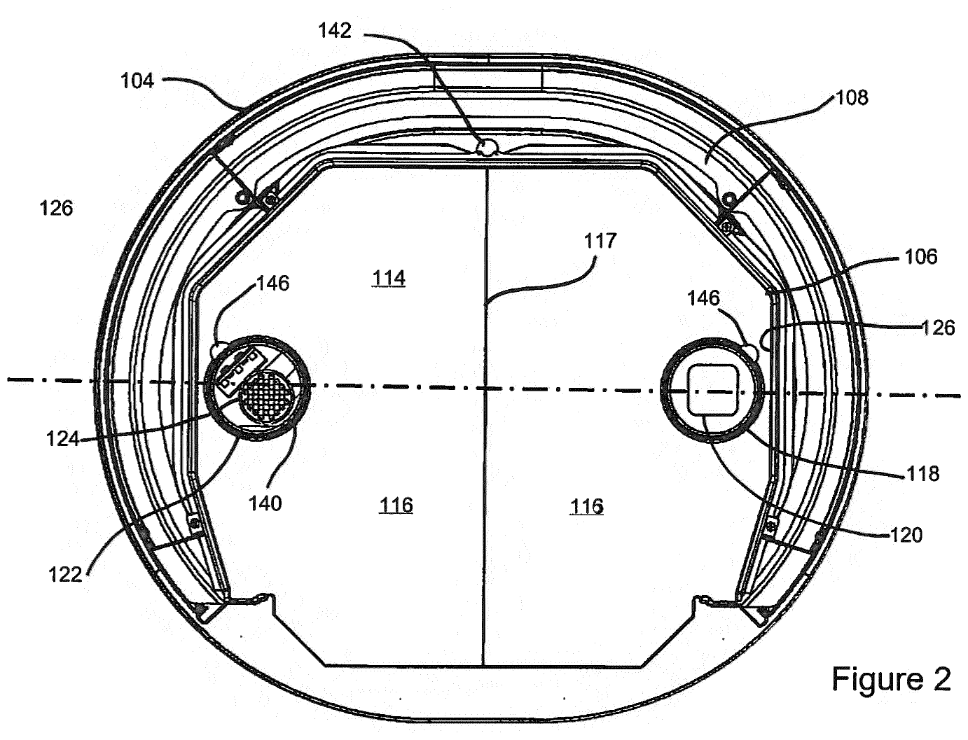

Referring now to FIG. 2, a sectional plan view of the oven 100 is shown. FIG. 2 shows the oven 100 viewed vertically downwards on the plane S-S shown in FIG. 1.

As can be appreciated in this view, the oven chamber 110 has an oven floor 114 which forms the base of the oven chamber 110. The oven floor 114 is configured to be arranged in a substantially horizontal plane in use, so as to provide a support surface for supporting foodstuffs to be cooked or cured in the oven chamber. The oven floor 114 is a thick stone floor. Ovens of the type of this example typically have this type of thick stone floor which absorbs heat from the energy source of the oven such that the underside of foodstuffs (such as pizza) can be heated efficiently. In other examples, the oven floor may be formed from other materials.

In this case, the oven floor 114 is formed from two oven floor panels 116 which abut at a central line 117 which extends from the front of the oven at the oven mouth 112 to the back of the oven 100. Although the oven floor is formed from two panels 116 (or could be formed from more than two panels or pieces) it should be understood that they combine to form a substantially continuous surface, aside from the energy source apertures which will be described in more detail below. In other examples, the oven floor 114 may be formed from a single panel. The continuous surface may be formed from more than one floor panel, but there may be essentially no gaps between separate panels of the oven floor.

It should be appreciated that there are many types of processes which can come under the term “cooking” and “curing”. In the context of the present disclosure, these terms should be understood to encapsulate various methods of treating foodstuffs in the oven by applying energy to them from an energy source. For example, other than simply heating, cooking may include (but is not limited to) heating, roasting, steaming, or baking foodstuffs. Further, curing may include (but is not limited to) hot-smoking, cold-smoking, or dehydrating foodstuffs.

As can be appreciated in the plan view of FIG. 2, the oven floor 114 comprises two apertures: a first aperture 118 for communication with a first, non-gas-fuel energy source 120 for cooking or curing foodstuffs in the oven chamber; and a second aperture 122 for communication with a second, gas-fuel energy source 124 for cooking or curing foodstuffs in the oven chamber. In other examples, the first and second energy sources may be different types of energy source.

The first aperture 118 is arranged on a right side of the oven floor 114 (when viewed from the front) adjacent the peripheral edge 126 of the oven chamber 110, which is defined by the inner housing layer 106. The second aperture 122 is arranged on a left side of the oven floor 114 (when viewed from the front) adjacent the peripheral edge of the oven chamber 110. Accordingly, the two apertures 118,122 are spaced apart across the oven floor 114 on opposing sides of the oven mouth 112. This conveniently arranges the apertures away from the central area of the oven floor 114, which provides improved area for foodstuffs.

Referring additionally to FIG. 3, which discloses a sectional perspective viewed on the plane T-T in FIG. 2, the construction of the oven 100 is shown in more detail.

The first aperture 118 is formed at an upper end of a cavity 128 which extends generally vertically down from the oven floor. The cavity 128 comprises an energy source chamber 130 and a vertically-extending conduit 132 which connects the first aperture 118 and the energy source chamber 130. The energy source chamber 130 is configured to receive a non-gas-fuel energy source 120, such as wood, flammable pellets, liquid fuel, a steam generator, or a smoker. The non-gas fuel energy source 120 can be used to introduce energy into the oven chamber 110 via the conduit 132. By “introducing energy” into the oven chamber 110, it should be understood that energy-laden fluid which performs the cooking or curing is introduced into the oven chamber 110, such as heated air, steam, and/or smoke. Although a non-gas-fuel energy source may introduce energy into the oven chamber using gas emitted by the non-gas-fuel energy source, it should be understood that the fuel which is converted within the energy source is not itself gas. A steam generator, for example, should be understood to be a non-gas-fuel energy source even though it might not be powered by any sort of solid or liquid flammable fuel per se, and could, for example, be powered by electricity from a mains or battery source.

The second aperture 122 is formed at an upper end of a gas-burner chamber 134 which extends generally vertically down from the oven floor 114. The gas-fuel energy source 124 in this case is a gas burner 136 for burning flammable gas to introduce heat energy (and possibly smoke) into the oven chamber 110. In this example, the gas burner 136 is permanently fixed within the gas-burner chamber 134 below the second aperture 122. The gas burner 136 is connected via a gas conduit 138 to a gas fuel source, such as a gas canister, or mains gas supply (not shown).

The oven floor 114 is substantially impermeable. Accordingly, energy from the energy sources will predominantly pass into the oven cavity via the first and/or second apertures 118, 122.

In this example, the second aperture 122 is surrounded by a peripheral wall 140 which projects upwardly from the oven floor 114. This peripheral wall 140 helps to prevent debris from falling into the second aperture 122, which could damage or otherwise affect the operation of the gas burner 136. In other examples, a peripheral wall may also be provided about the first aperture. The peripheral wall 140 may be removable.

Providing both gas-fuel and non-gas-fuel energy sources to the oven chamber 110 provides that the oven is extremely versatile for performing many different cooking and curing methods. Gas-fuel energy sources, which are typically very bulky and are therefore more difficult to provide safely and effectively in a removable way, have a dedicated heating aperture for heating the oven. However, non-gas-fuel energy sources, such as wood or flammable pellets, which are more readily replaceable and swappable, also have their own dedicated heating aperture. Accordingly, heating with each type of energy source can be tailored more easily and safely by the user with the oven in-situ.

A complication with providing two energy sources in different locations in the oven chamber is that, if it is desired to sense the temperature in the oven for any reason, it may be difficult to accurately achieve sensing when different energy sources are used. In this example, the oven comprises a temperature sensor 142 for measuring a temperature within the oven chamber 110. As will be appreciated from FIG. 3, the first and second apertures 118,122 are both arranged the same distance away from the temperature sensor 142 within the oven chamber 110. Accordingly, regardless of which energy source is being used, the temperature sensor 142 is the same distance from the energy source's entry point to the oven chamber 110, so more accurate and consistent readings may be provided.

Furthermore, providing an arrangement in which both types of energy source can be used simultaneously, a wider range of cooking and curing methods can be achievable. For example, the quick and efficient cooking which can be achieved with a gas burner from the second aperture 122 can be supplemented by a real wood fire from the first aperture 118 for added flavor.

Although the oven described herein provides many advantages from the provision of separate apertures for gas and non-gas energy sources, it will be apparent that, in many cooking or curing scenarios, only one of the gas-fuel and non-gas-fuel energy sources will be required. Accordingly, the oven is readily customizable to optimize the oven for the best performance and capacity for the particular cooking or curing method being used. In addition, the present arrangement allows a user to switch between different energy or heat sources without having to open or interact with the interior of the oven chamber, or move the oven (which may be difficult when the oven is hot in use).

It should be understood that, although the heat sources in these specific examples utilize gas and/or non-gas fuel, ovens utilizing electrical energy sources, such as radiant elements or fan heaters are equally possible within the principles of this disclosure.

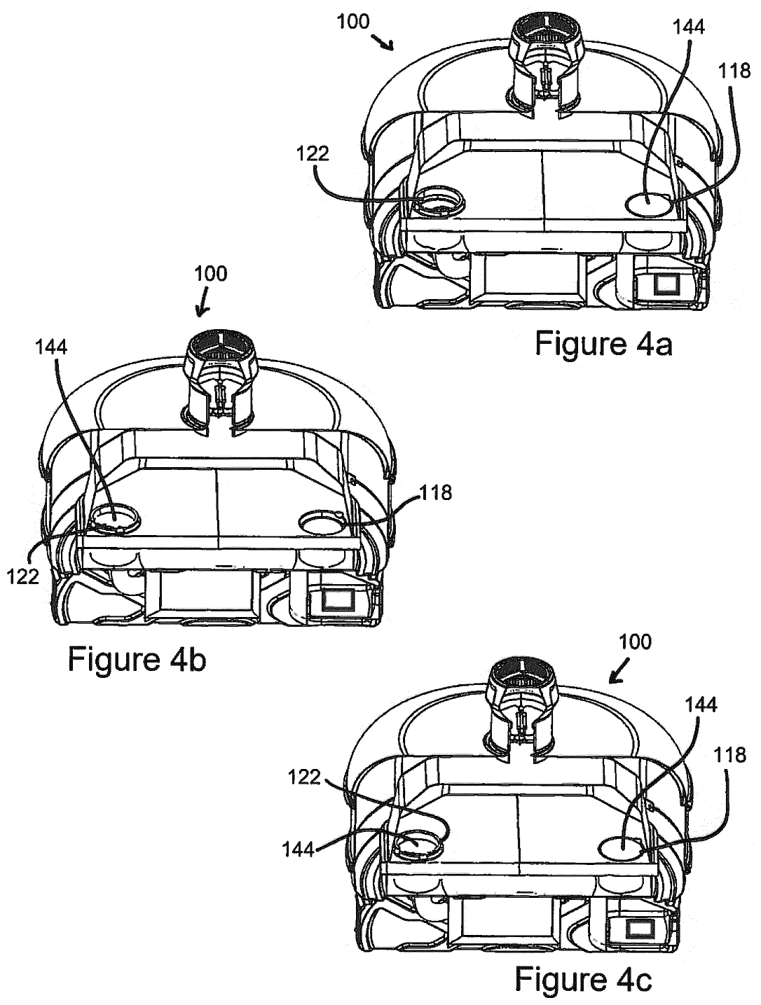

As shown in FIGS. 4a-c, the oven may be provided with one or more blanking caps 144 for selectively covering the first and/or second apertures 118,122. The blanking cap 144 may be used to cover and protect each of the energy sources 120,136 when they are not in use.

Furthermore, as the blanking caps 144 are, in this example, formed from substantially the same material as the oven floor 114, and fit snugly into the apertures 118,122, they effectively form an extension of the oven floor 114 and therefore provide additional cooking area on the oven floor 114.

It will be appreciated that, in this example, the first and second apertures 118,122 are identical in size and shape. Although not all examples will exhibit this feature, this is convenient for manufacturing purposes as the apertures 118,122 can be made more efficiently. Furthermore, providing apertures of the same shape permits that a universal blanking cap 144 may be used to cover either of the first or second apertures 118,122.

In FIG. 4a, the oven 100 is shown in a first configuration, in which only the gas burner 136 is to be used. Here, a blanking cap 144 is placed in the first aperture 118 to maximize the oven floor area and prevent foodstuffs from falling into the first aperture 118.

In FIG. 4b, the oven is shown in a second configuration, in which only a non-gas-fuel energy source 120 is to be used. Here, a blanking cap 144 is placed in the second aperture 122 to maximize the oven floor area and prevent foodstuffs from falling into the second aperture 122. It may be particularly important to close the second aperture 122 when the gas burner 136 is not in use. If debris were to fall into the second aperture 122, it could block or damage the gas burner 136.

In a third configuration shown in FIG. 4c, both of the first and second apertures 118,122 are provided with a respective blanking caps 144. This configuration might be used, for example, when an energy source inside the oven chamber is to be used, for example a log fire formed directly on the oven floor 114. In such a scenario, the blanking caps 144 maximize the cooking area and prevent debris from damaging or otherwise affecting the gas- or non-gas-energy sources.

In this example, the first and second apertures 118,122 are circular in shape. This design means that a complimentarily-shaped circular blanking cap 144 can conveniently inserted into either of the apertures 118,122 in any rotational orientation.

It will be appreciated that the oven floor 114 features a relief 146 at the periphery of each of the first and second apertures 118,122. These reliefs 146 may aiding the removal of a blanking cap 144 from the apertures by permitting the insertion of a tool or a user's finger to gain more purchase or leverage on the blanking cap 144.

If the oven 100 is being used with a curing energy source, such as a smoker or pellet burner, the oven 100 may be provided with a removable door (not shown) which can be used to can be used to seal the oven chamber 110 from the ambient environment to prevent loss of smoke from the oven chamber. In one configuration, the door may completely seal the oven mouth 112 to prevent any escape of gases from the oven chamber 110, such as may be desirable during smoking. In another configuration, the oven 100 may be provided with a door which seals the oven chamber from the ambient environment via the oven mouth 112, but is also configured to permit the expulsion of gases from the oven chamber 110 via its flue and chimney, such as may desirable during cooking with wood or pellets to maintain a smoky environment in the oven chamber 110.

To avoid unnecessary duplication of effort and repetition of text in the specification, certain features are described in relation to only one or several aspects of the invention. However, it is to be understood that, where it is technically possible, features described in relation to any aspect of the invention may also be used with any other aspect of the invention.

It will be appreciated by a skilled person that although the invention has been described by way of example, with reference to exemplary examples, it is not limited to the disclosed examples and that alternative examples could be constructed without departing from the scope as defined by the appended claims.

1. An oven comprising:
an oven housing defining an oven chamber for containing foodstuffs during cooking or curing; and
an oven floor forming a base of the oven chamber for supporting foodstuffs to be cooked or cured in the oven chamber, wherein the oven floor comprises:
a first aperture for communication with a first energy source for cooking foodstuffs in the oven chamber; and
a second aperture for communication with a second energy source for cooking foodstuffs in the oven chamber.

2. An oven as claimed in claim 1, wherein the first energy source is a non-gas fuel energy source, and the second energy source is a gas-fuel energy source.

3. An oven as claimed in claim 1, further comprising a blanking cap for selectively covering the second aperture.

4. An oven as claimed in claim 1 further comprising a blanking cap for selectively covering the first aperture.

5. An oven as claimed in claim 1, wherein the first and second apertures are substantially identical in size and/or shape.

6. An oven as claimed in claim 1, wherein the first and/or second aperture is circular in shape.

7. An oven as claimed in claim 4, wherein the blanking cap or blanking caps are circular in shape.

8. An oven as claimed in claim 2, wherein the one or more blanking caps are formed from substantially the same material as the oven floor, and/or from cast iron.

9. An oven as claimed in claim 2, wherein the first and second apertures are spaced apart across a width of the oven floor, optionally wherein the first and second apertures are arranged on opposing lateral areas of the oven floor and/or on opposing lateral sides of an oven mouth of the oven that provides access to the oven chamber.

10. An oven as claimed in claim 1, wherein the first and second apertures are each arranged proximate a peripheral edge of the oven floor.

11. An oven as claimed in claim 1, wherein the oven chamber comprises a temperature sensor for measuring a temperature within the oven chamber, and the first and second apertures are arranged substantially equidistant from the temperature sensor.

12. An oven as claimed in claim 1, wherein the non-gas-fuel energy source is arranged below the oven floor, optionally, arranged within a chamber formed below the first aperture.

13. An oven as claimed in claim 1, wherein the second aperture contains a permanent gas-fuel energy source.

14. An oven as claimed in claim 1, wherein the first and/or second aperture is surrounded by a peripheral wall, optionally a removable peripheral wall, which projects upwardly from the oven floor.

15. An oven as claimed in claim 1, wherein the oven floor is a substantially continuous surface.

16. An oven as claimed in claim 1, wherein the oven floor comprises a relief at the periphery of the first and/or second aperture for aiding removal of a blanking cap from the aperture.
